(19) United States
(12) Patent Application Publication
(10) Pub. No.: US 2026/0133741 A1
(43) Pub. Date: May 14, 2026

(54) MULTI-PANEL DISPLAY METHOD AND APPARATUS THEREOF

(71) Applicant: MediaTek Singapore Pte. Ltd., Singapore (SG)

(72) Inventor: Zhangjun YU, Wuhan (CN)

(21) Appl. No.: 18/941,339

(22) Filed: Nov. 8, 2024

(51) Int. Cl. G06F 3/14

(52) U.S. Cl. CPC G06F 3/1431

(57) ABSTRACT

A multi-panel display method is provided. The multi-panel display method includes the following steps. A graphics compositing module of the apparatus may establish a plurality of graphics compositing threads. Each graphics compositing thread may correspond to a frame to be displayed on one display device. The graphics compositing module may process data of the frames through the graphics compositing threads. A hardware composer module of the apparatus may establish a plurality of overlay (OVL) threads. Each OVL thread may correspond to one graphics compositing thread and one display device. The hardware composer module may process the composited data from the graphics compositing module through the overlay threads. The display devices may display the frames from the hardware composer module.

### BACKGROUND OF THE INVENTION

Field of the Invention

The invention generally relates to multi-panel display technology, and more particularly, it relates to a multi-panel display technology in which multi-treads are respectively used to process data corresponding to the different display devices.

### Description of the Related Art

With the development of display technologies, there are more requirements on multi-panel displays. In conventional multi-panel display technology, when different applications (APP) performed on different display devices of an apparatus, the apparatus may process the data corresponding to different display devices serially. That is, the apparatus may need to process the data corresponding to different display devices in order. For example, the apparatus may process the data of one display device first, and then process the data of another display device.

However, when the quantity of the data of the APPs is too large, the apparatus may not have enough processing time to process the data of all APPs performed on different display devices during the synchronization time (e.g., a period of time corresponding to SurfaceFlinger (SF) vertical synchronization (VSYNC) signal. As a result, the dropped frame may be occurred, i.e., the user experience may be decreased.

For example, when the refresh rate of the display device is 120 Hertz (Hz), the synchronization time may be 8.3 milliseconds (ms). That is, after receiving the VSYNC signal, the graphics compositing module (e.g., SurfaceFlinger of Android system) of the apparatus may need process the data of all APPs performed on different display devices within 8.3 ms. Otherwise, the dropped frame may be occurred.

Therefore, how to reduce the above problem of multi-panel display is a topic that is worthy of discussion.

### BRIEF SUMMARY OF THE INVENTION

A multi-panel display method and apparatus are provided to overcome the problems mentioned above.

An embodiment of the invention provides a multi-panel display method. The multi-panel display method includes the following steps. A graphics compositing module of the apparatus may establish a plurality of graphics compositing threads. Each graphics compositing thread may correspond to a frame to be displayed on one display device. The graphics compositing module may process data of the frames through the graphics compositing threads. A hardware composer module of the apparatus may establish a plurality of overlay (OVL) threads. Each OVL thread may correspond to one graphics compositing thread and one display device. The hardware composer module may process the composited data from the graphics compositing module through the overlay threads. The display devices may display the frames from the hardware composer module.

In some embodiments, the graphics compositing module is SurfaceFlinger of Android system.

In some embodiments, the hardware composer module is hardware composer (HWC) hardware abstraction layer (HAL) of Android system.

In some embodiments, the graphics compositing module may establish the graphics compositing threads after receiving a vertical synchronization signal.

In some embodiments, each graphics compositing thread may correspond to a panel identification (ID). The graphics compositing module may receive the data corresponding to different display devices through different graphics compositing threads according to the panel ID corresponding to each graphics compositing thread.

In some embodiments, each OVL thread corresponds to a panel ID. The graphics compositing module may transmit the composited data to each OVL thread according to the panel ID corresponding to each OVL thread.

An embodiment of the invention provides a multi-panel display apparatus. The multi-panel display apparatus may include a plurality of display devices and a processor. The processor may be coupled to the display devices. The processor may be also configured to establish, via a graphics compositing module, a plurality of graphics compositing threads. Each graphics compositing thread may correspond to a frame to be displayed on one display device. The processor may be further configured to process, via the graphics compositing module, data of the frames through the graphics compositing threads. The processor may be further configured to establish, via a hardware composer module a plurality of overlay (OVL) threads. Each OVL thread may correspond to one graphics compositing thread and one display device. The processor may be further configured to process, via the hardware composer module, the composited data from the graphics compositing module through the overlay threads. The processor may be further configured to display, via the display devices, frames from the hardware composer module.

Other aspects and features of the invention will become apparent to those with ordinary skill in the art upon review of the following descriptions of specific embodiments of multi-panel display method and an apparatus.

### BRIEF DESCRIPTION OF THE DRAWINGS

The invention will become more fully understood by referring to the following detailed description with reference to the accompanying drawings, wherein:

FIG. 1 is a block diagram of a multi-panel display apparatus 100 according to an embodiment of the application.

FIG. 2 is a schematic diagram illustrating a multi-panel display application scenario according to an embodiment of the invention.

FIG. 3 is a schematic diagram illustrating a multi-thread process according to an embodiment of the invention.

FIG. 4 is a flow chart illustrating a multi-panel display method according to another embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

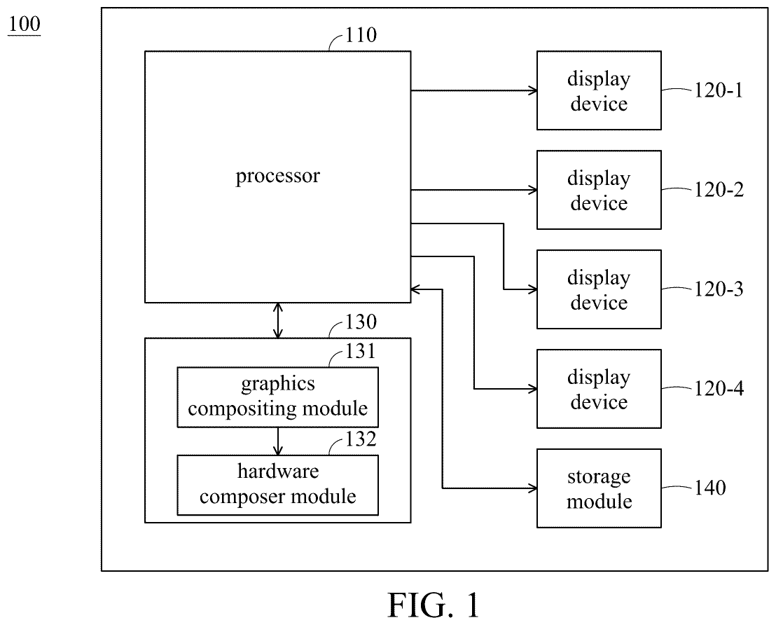

FIG. 1 is a block diagram of a multi-panel display apparatus 100 according to an embodiment of the application. As shown in FIG. 1, the multi-panel display apparatus 100 may comprise a processor 110, display devices 120-1˜120-4, a graphic function modules and circuits 130, and a storage device 140. It should be noted that FIG. 1 presents a simplified block diagram in which only the elements relevant to the invention are shown. However, the invention should not be limited to what is shown in FIG. 1. For example, the multi-panel display apparatus 100 may comprise other elements. In addition, the multi-panel display apparatus 100 may comprise other number of display devices.

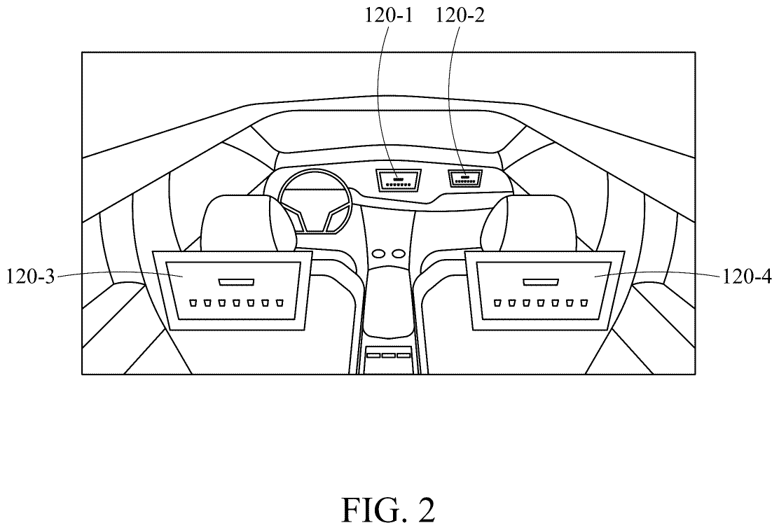

The multi-panel display apparatus 100 may be an electronic device with multi-panel display function, e.g., an on-board computer, but the invention should not be limited thereto. FIG. 2 is a schematic diagram illustrating a multi-panel display application scenario according to an embodiment of the invention. As shown in FIG. 2, the multi-panel display apparatus 100 may be configured in a car. The processor 110 of the multi-panel display apparatus 100 may control the display contents of the display devices 120-1˜120-4. The display devices 120-1˜120-4 may display the same or different contents for different applications (APPs).

The processor 110 may be a general-purpose processor, a Central Processing Unit (CPU), a Micro Control Unit (MCU), an application processor, a Digital Signal Processor (DSP), a Graphics Processing Unit (GPU), a Holographic Processing Unit (HPU), a Neural Processing Unit (NPU), or the like, which includes various circuits for providing the functions of data processing and computing to control the display devices 120-1˜120-4, the graphic function modules and circuits 130, and the storage device 140. The processor 110 may coordinate the operations of the display devices 120-1˜120-4, the graphic function modules and circuits 130, and the storage device 140 for performing the method of the present application.

In some embodiments, the multi-panel display apparatus 100 may further comprise two processors, e.g. a CPU and a GPU. The GPU may be used to offload graphic (or image) processing tasks from the CPU. In some examples, the CPU and the GPU may be formed in an integrated circuit (IC). For example, the IC may be considered as a processing chip within a chip package, or it may be considered to be a system on a chip or portion thereof. In some examples, the CPU and the GPU may be housed in different integrated circuits (i.e., different chip packages).

Examples of the CPU and the GPU may include, but are not limited to, a digital signal processor (DSP), general purpose microprocessor, application specific integrated circuit (ASIC), field programmable logic array (FPGA), or other equivalent integrated or discrete logic circuitry. In some examples, the GPU may be specialized hardware that includes integrated and/or discrete logic circuitry that provides the GPU with massive parallel processing capabilities suitable for graphics processing. In some instances, the GPU may also include general purpose processing capabilities, and may be referred to as a general purpose GPU (GPGPU) when implementing general purpose processing tasks (i.e., non-graphics related tasks).

As will be appreciated by persons skilled in the art, the circuits of the processor 110 (e.g., CPU or GPU) may include transistors that are configured in such a way as to control the operation of the circuits in accordance with the functions and operations described herein. As will be further appreciated, the specific structure or interconnections of the transistors may be determined by a compiler, such as a Register Transfer Language (RTL) compiler. RTL compilers may be operated by a processor upon scripts that closely resemble assembly language code, to compile the script into a form that is used for the layout or fabrication of the ultimate circuitry. Indeed, RTL is well known for its role and use in the facilitation of the design process of electronic and digital systems.

The display devices 120-1˜120-4 may be Liquid-Crystal Displays (LCDs), Light-Emitting Diode (LED) displays, Organic LED (OLED) displays, or an Electronic Paper Displays (EPDs), etc., for providing a display function. Alternatively, the display devices 120-1˜120-4 may further include one or more touch sensors for sensing touches, contacts, or approximations of objects, such as fingers or styluses. The display devices 120-1˜120-4 may respectively display different contents corresponding to different applications performed by the user (or users).

The graphic function modules and circuits 130 may comprise a graphics compositing module 131 (e.g., SurfaceFlinger of Android system) and a hardware composer module 132 (e.g., hardware composer (HWC) hardware abstraction layer (HAL) of Android system). The processor 110 may execute different modules or circuits in the function modules and circuits 130 to perform embodiments of the present invention. It should be noted that the graphic function modules and circuits 130 of FIG. 1 presents a simplified block diagram in which only the elements relevant to the invention are shown. However, the invention should not be limited to what is shown in FIG. 1. The graphic function modules and circuits 130 may further comprise other graphic function modules and/or circuits. According to the embodiments of the invention, the multi-panel display apparatus 100 may further comprise a display controller (not shown in FIG. 1) to receive the data and signal from hardware composer module 132 to display the data from the hardware composer module 132 on the display devices 120-1˜120-4.

The storage device 140 may be a non-transitory machine-readable storage medium, including a memory, such as a FLASH memory or a Non-Volatile Random Access Memory (NVRAM), or a magnetic storage device, such as a hard disk or a magnetic tape, or an optical disc, or any combination thereof for storing data, instructions, and/or program code of applications, communication protocols, and/or the method of the present application.

According to an embodiment of the invention, an apparatus (e.g., multi-panel display apparatus 100) may perform different applications (APPs) on its different display devices (e.g., display devices 120-1˜120-4), the APPs may transmit the data to the graphics compositing module (e.g., SurfaceFlinger (SF) of Android system) of the apparatus. Specifically, after the graphics compositing module receives a vertical synchronization signal (e.g., SF VSYNC signal), the graphics compositing module may establish different graphics compositing threads for different display devices with different panel identifications (IDs). Each graphics compositing thread may correspond to a frame to be displayed on one display device with a panel ID. In an embodiment, each graphics compositing thread may correspond to a panel ID. Therefore, the APPs may transmit the data corresponding to different display devices to the graphics compositing threads according to its corresponding panel IDs. Then, the graphics compositing module (e.g., SurfaceFlinger) may process the data of the frames from the APPs (e.g., parse and composite the data from the APP) through the graphics compositing threads to generate composited data. The composited data may comprise the information of different graphic layers of the data from the APPs, e.g., the position of the graphic layers, the orders of the graphic layers, and so on. Accordingly, in the embodiments of the invention, the graphics compositing module can process the data corresponding to different display devices in parallel.

After the graphics compositing module (e.g., SurfaceFlinger) composite the drawn data, the graphics compositing module may transmit the composited data to the hardware composer module (e.g., HWC HAL of Android system). According to an embodiment of the invention, the hardware composer module may also establish different overlay (OVL) threads for different display devices with different panel identifications (IDs). In an embodiment, each OVL thread may correspond to a panel ID. Therefore, the graphics compositing module may transmit the composited data corresponding to different display devices to the OVL threads according to its corresponding panel IDs. That is, the graphics compositing module may transmit the composited data from a graphics compositing thread to an OVL thread corresponding to the same panel ID as this graphics compositing thread. Then, the hardware composer module (e.g., HWC HAL) may process the composited data (e.g., compose the composited data) through the OVL threads to generate composed data (e.g., an image frame). That is, in the embodiments of the invention, the graphics compositing module can process the composited data corresponding to different display devices in parallel.

After the hardware composer module receives an interrupt signal (i.e., the SF VSYNC signal is interrupted), the hardware composer module may transmit the composed data (i.e., frames corresponding to different display devices) to different display devices through the OVL threads according to the panel IDs. Then, the display devices may display the composed data from its corresponding OVL threads the hardware composer module.

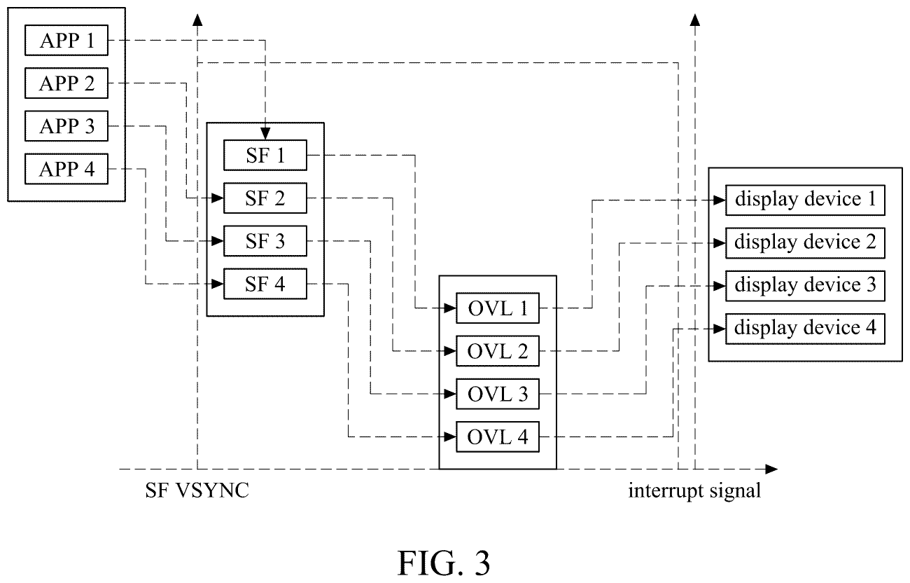

FIG. 3 is a schematic diagram illustrating a multi-thread process according to an embodiment of the invention. As shown in FIG. 3, the APP 1 is performed on the display device 1, the APP 2 is performed on the display device 2, the APP3 is performed on the display device 3, and the APP4 is performed on the display device 4. The APP 1 may transmit the data to the graphics compositing thread SF 1 corresponding to the display device 1. The APP 2 may transmit the data to the graphics compositing thread SF 2 corresponding to the display device 2. The APP 3 may transmit the data to the graphics compositing thread SF 3 corresponding to the display device 3. The APP 4 may transmit the data to the graphics compositing thread SF 4 corresponding to the display device 4. When the graphics compositing module (e.g., SurfaceFlinger) receives the vertical synchronization signal (e.g., SF VSYNC signal), the graphics compositing module may process the data from the APP 1˜APP 4 through the graphics compositing threads SF 1˜SF 4. Then, the graphics compositing module may transmit composited data corresponding to the display device 1 from the graphics compositing thread SF 1 to the OVL thread OVL 1 corresponding to the display device 1. The graphics compositing module may also transmit composited data corresponding to the display device 2 from the graphics compositing thread SF 2 to the OVL thread OVL 2 corresponding to the display device 2. The graphics compositing module may also transmit composited data corresponding to the display device 3 from the graphics compositing thread SF 3 to the OVL thread OVL 3 corresponding to the display device 3. The graphics compositing module may also transmit composited data corresponding to the display device 4 from the graphics compositing thread SF 4 to the OVL thread OVL 4 corresponding to the display device 4. After the hardware composer module receives an interrupt signal, the display device 1 may display the composed data from the OVL thread OVL 1. The display device 2 may display the composed data from the OVL thread OVL 2. The display device 3 may display the composed data from the OVL thread OVL 3. The display device 4 may display the composed data from the OVL thread OVL 4.

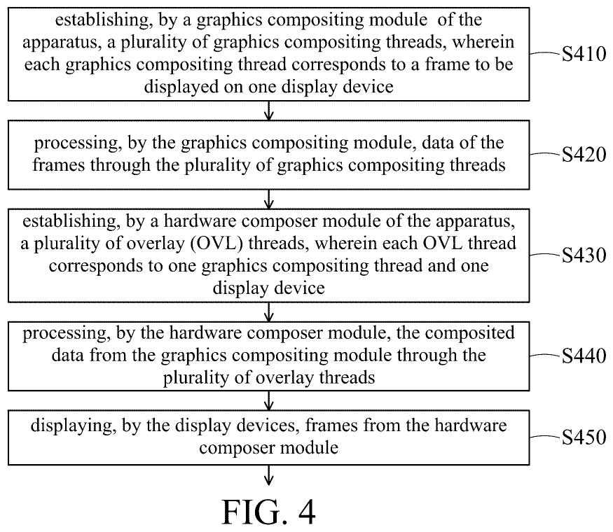

FIG. 4 is a flow chart illustrating a multi-panel display method according to an embodiment of the invention. The multi-panel display method can be applied to the multi-panel display apparatus 100. As shown in FIG. 4, in step S410, a graphics compositing module of the multi-panel display apparatus 100 may establish a plurality of graphics compositing threads. Each graphics compositing thread may correspond to a frame to be displayed on one display device.

In step S420, the graphics compositing module may process the data of the frame through the graphics compositing threads.

In step S430, a hardware composer module of the multi-panel display apparatus 100 may establish a plurality of overlay (OVL) threads. Each OVL thread may correspond to one graphics compositing thread and one display device.

In step S440, the hardware composer module may process the composited data from the graphics compositing module through the OVL threads.

In step S450, the display devices may display the frames from the hardware composer module.

According to an embodiment of the invention, in the multi-panel display method, the graphics compositing module may be SurfaceFlinger of Android system.

According to an embodiment of the invention, in the multi-panel display method, the hardware composer module may be hardware composer (HWC) hardware abstraction layer (HAL) of Android system.

According to an embodiment of the invention, in the multi-panel display method, the graphics compositing module may establish the graphics compositing threads after receiving a vertical synchronization signal.

According to an embodiment of the invention, in the multi-panel display method, each graphics compositing thread may correspond to a panel ID. The graphics compositing module may receive the data corresponding to different display devices through different graphics compositing threads according to the panel ID corresponding to each graphics compositing thread.

According to an embodiment of the invention, in the multi-panel display method, each OVL thread corresponds to a panel ID. The graphics compositing module may transmit the composited data to each OVL thread according to the panel ID corresponding to each OVL thread.

According to the multi-panel display method provided in the invention, the data corresponding to the different display devices can be processed by multi-treads (e.g., graphics compositing threads and the OVL threads) in parallel. Therefore, the processing time can be reduced and the dropped frame can be avoided.

Use of ordinal terms such as “first”, “second”, “third”, etc., in the disclosure and claims is for description. It does not by itself connote any order or relationship.

The steps of the method described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such that the processor can read information (e.g., code) from and write information to the storage medium. A sample storage medium may be integral to the processor. The processor and the storage medium may reside in an ASIC. The ASIC may reside in the UE. In the alternative, the processor and the storage medium may reside as discrete components in the UE. Moreover, in some aspects, any suitable computer-program product may comprise a computer-readable medium comprising codes relating to one or more of the aspects of the disclosure. In some aspects, a computer software product may comprise packaging materials.

It should be noted that although not explicitly specified, one or more steps of the methods described herein can include a step for storing, displaying and/or outputting as required for a particular application. In other words, any data, records, fields, and/or intermediate results discussed in the methods can be stored, displayed, and/or output to another device as required for a particular application. While the foregoing is directed to embodiments of the present invention, other and further embodiments of the invention can be devised without departing from the basic scope thereof. Various embodiments presented herein, or portions thereof, can be combined to create further embodiments. The above description is of the best-contemplated mode of carrying out the invention. This description is made for the purpose of illustrating the general principles of the invention and should not be taken in a limiting sense. The scope of the invention is best determined by reference to the appended claims.

The above paragraphs describe many aspects. Obviously, the teaching of the invention can be accomplished by many methods, and any specific configurations or functions in the disclosed embodiments only present a representative condition. Those who are skilled in this technology will understand that all of the disclosed aspects in the invention can be applied independently or be incorporated.

While the invention has been described by way of example and in terms of preferred embodiment, it should be understood that the invention is not limited thereto. Those who are skilled in this technology can still make various alterations and modifications without departing from the scope and spirit of this invention. Therefore, the scope of the present invention shall be defined and protected by the following claims and their equivalents.

1. A multi-panel display method, comprising:
establishing, by a graphics compositing module of an apparatus, a plurality of graphics compositing threads, wherein each graphics compositing thread corresponds to a frame to be displayed on one display device;
processing, by the graphics compositing module, data of the frames through the plurality of graphics compositing threads;
establishing, by a hardware composer module of the apparatus, a plurality of overlay (OVL) threads, wherein each OVL thread corresponds to one graphics compositing thread and one display device;
processing, by the hardware composer module, the composited data from the graphics compositing module through the plurality of overlay threads; and
displaying, by the plurality of display devices, frames from the hardware composer module.

2. The multi-panel display method of claim 1, wherein the graphics compositing module is a SurfaceFlinger module.

3. The multi-panel display method of claim 1, wherein the hardware composer module is a hardware composer (HWC) hardware abstraction layer (HAL).

4. The multi-panel display method of claim 1, further comprising:
establishing, by the graphics compositing module, the plurality of graphics compositing threads after receiving a vertical synchronization signal.

5. The multi-panel display method of claim 1, wherein each graphics compositing thread corresponds to a panel ID, and the method further comprises:
receiving, by the graphics compositing module, the data corresponding to different display devices through different graphics compositing threads according to the panel ID corresponding to each graphics compositing thread.

6. The multi-panel display method of claim 5, wherein each OVL thread corresponds to a panel ID, and the method further comprises:
transmitting, by the graphics compositing module, the composited data to each OVL thread according to the panel ID corresponding to each OVL thread.

7. A multi-panel display apparatus, comprising:
a plurality of display devices; and
a processor, coupled to the plurality of display devices, and configured to:
establish, via a graphics compositing module, a plurality of graphics compositing threads, wherein each graphics compositing thread corresponds to a frame to be displayed on one display device;
process, via the graphics compositing module, data of the frames through the plurality of graphics compositing threads;
establish, via a hardware composer module a plurality of overlay (OVL) threads, wherein each OVL thread corresponds to one graphics compositing thread and one display device;
process, via the hardware composer module, the composited data from the graphics compositing module through the plurality of overlay threads; and
display, via the plurality of display devices, frames from the hardware composer module.

8. The multi-panel display apparatus of claim 7, wherein the graphics compositing module is a SurfaceFlinger module.

9. The multi-panel display apparatus of claim 7, wherein the hardware composer module is a hardware composer (HWC) hardware abstraction layer (HAL).

10. The multi-panel display apparatus of claim 7, wherein the processor is further configured to:
establish, via the graphics compositing module, the plurality of graphics compositing threads after receiving a vertical synchronization signal.

11. The multi-panel display apparatus of claim 7, wherein each graphics compositing thread corresponds to a panel ID, and the processor is further configured to:
receive, via the graphics compositing module, the data corresponding to different display devices through different graphics compositing threads according to the panel ID corresponding to each graphics compositing thread.

12. The multi-panel display apparatus of claim 11, wherein each OVL thread corresponds to a panel ID, and the processor is further configured to:
transmit, via the graphics compositing module, the composited data to each OVL thread according to the panel ID corresponding to each OVL thread.
